(19) United States
(12) Patent Application Publication
(10) Pub. No.: US 2013/0346677 A1
(43) Pub. Date: Dec. 26, 2013

(54) NON-VOLATILE MEMORY DEVICE

(71) Applicant: SAMSUNG ELECTRONICS CO., LTD., SUWON-SI (KR)

(72) Inventors: JAE-GEUN PARK, SEOUL (KR); SEUNG-WON LEE, GOYANGSI (KR); YOUNG-JIN CHO, SEOUL (KR); EUI-HYEOK KWON, HWASEONG-SI (KR); CHUL-SEUNG LEE, HWASEONG-SI (KR)

(73) Assignee: SAMSUNG ELECTRONICS CO., LTD., SUWON-SI (KR)

(21) Appl. No.: 13/786,911

(22) Filed: Mar. 6, 2013

(30) Foreign Application Priority Data
Jun. 26, 2012 (KR) 10-2012-0068532

(51) Int. Cl. G06F 12/02

(52) U.S. Cl. CPC G06F 12/0246
USPC 711/103

(57) ABSTRACT

A non-volatile memory device comprises a first storage unit which stores mapping information between a plurality of first addresses and a plurality of second addresses, and data; a second storage unit having a storage capacity smaller than that of the first storage unit; and a decoder which receives a first read address that is one of the plurality of first addresses, and while the mapping information is provided from the first storage unit to the second storage unit in order to locate a second read address that is one of the plurality of second addresses and corresponds to the first read address, applies a read command for reading data corresponding to the second read address to the first storage unit.

### CROSS-REFERENCE TO RELATED APPLICATION

This application claims priority to Korean Patent Application No. 10-2012-0068532 filed on Jun. 26, 2012 in the Korean Intellectual Property Office, and all the benefits accruing therefrom under 35 U.S.C. 119, the disclosure of is incorporated by reference in its entirety herein.

### BACKGROUND

1. Technical Field

The present inventive concept relates to a non-volatile memory device.

2. Discussion of Related Art

A semiconductor memory device is a storage device which stores data such that the data can be read when necessary. Semiconductor memory devices may include non-volatile memory devices in which stored data is retained even when the power supply is interrupted, and volatile memory (VM) devices in which stored data is lost when the power supply is interrupted.

Examples of the non-volatile memory devices include programmable read-only memory (PROM), erasable PROM (EPROM), and electrically EPROM (EEPROM), flash memory device. Flash memory devices may include NOR flash memory devices and NAND flash memory devices. Examples of the volatile memory devices may include dynamic random access memory (DRAM) and static RAM (SRAM).

The time required to access (e.g., read and write) the data stored in the semiconductor memory device may affect the performance of electronic devices. Accordingly, there is a need for devices and methods that can reduce this access time.

### SUMMARY

At least one embodiment of the present inventive concept may provide a non-volatile memory device capable of reducing a read time required for reading stored data.

According to an exemplary embodiment of the present inventive concept, a non-volatile memory device includes: a first storage unit which stores mapping information between a plurality of first addresses and a plurality of second addresses, and data; a second storage unit having a storage capacity smaller than that of the first storage unit; and a decoder which receives a first read address that is one of the plurality of first addresses, and while the mapping information is provided from the first storage unit to the second storage unit to locate a second read address that is one of the plurality of second addresses and corresponds to the first read address, applies a read command for reading data corresponding to the second read address to the first storage unit.

According to an exemplary embodiment of the present inventive concept, a non-volatile memory device includes: a first storage unit which stores ‘n’ (‘n’ is a natural number) physical addresses corresponding to n logical addresses; a second storage unit which stores data; and a controller which in response to a first read command applied to read data corresponding to a first logical address, while ‘m’ (‘m’ is a natural number less than or equal to ‘n’) physical addresses including a first physical address corresponding to the first logical address among the ‘n’ physical addresses stored in the first storage unit are provided from the first storage unit, applies a second read command for reading data corresponding to the first physical address to the second storage unit.

According to an exemplary embodiment of the present inventive concept, a non-volatile memory device includes a controller comprising an internal memory storing only a first part of mapping information and a memory storage unit distinct from the controller, and storing the entire mapping information. The controller is configured to refer first to its internal memory to find a physical address that corresponds to a received logical address, and next refers to the memory storage unit to perform the find if the physical address is not found within the internal memory.

### BRIEF DESCRIPTION OF THE DRAWINGS

The present inventive concept will become more apparent by describing in detail exemplary embodiments thereof with reference to the attached drawings, in which:

FIG. 1 is a block diagram showing a non-volatile memory device in accordance with an exemplary embodiment of the present inventive concept;

FIG. 2 is a diagram for explaining a first memory unit shown in FIG. 1;

FIG. 3 is a diagram for explaining a second storage unit shown in FIG. 1;

FIG. 4 is a detailed block diagram of a decoder shown in FIG. 1 according to an exemplary embodiment of the present inventive concept;

FIG. 5 is a diagram for explaining a read operation of the non-volatile memory device in accordance with an exemplary embodiment of the present inventive concept;

FIG. 6 is a diagram showing exemplary operation timings of the components shown in FIG. 5;

FIG. 7 is a diagram for explaining a read operation of the non-volatile memory device in accordance with an exemplary embodiment of the present inventive concept;

FIG. 8 is a diagram showing exemplary operation timings of the components shown in FIG. 7;

FIGS. 9 and 10 are diagrams for explaining an effect of a non-volatile memory device in accordance with an exemplary embodiment of the present inventive concept;

FIG. 11 is a block diagram showing a non-volatile memory device in accordance with an exemplary embodiment of the present inventive concept;

FIG. 12 is a block diagram showing an application example of the non-volatile memory device in accordance with an exemplary embodiment of the present inventive concept; and

FIG. 13 is a block diagram showing a computing system including the non-volatile memory device in accordance with an exemplary embodiment of the present inventive concept.

### DETAILED DESCRIPTION

The present inventive concept and methods of accomplishing the same may be understood more readily by reference to the following detailed description of exemplary embodiments thereof and the accompanying drawings. The present inventive concept may, however, be embodied in many different forms and should not be construed as being limited to the exemplary embodiments set forth herein. In the drawings, the thickness of layers and regions may be exaggerated for clarity.

It will be understood that when an element or layer is referred to as being “on” or “connected to” another element or layer, it can be directly on or connected to the other element or layer or intervening elements or layers may be present. Like numbers refer to like elements throughout.

The use of the terms “a” and “an” and “the” and similar references in the context of describing the invention (especially in the context of the following claims) are to be construed to cover both the singular and the plural, unless otherwise indicated herein or clearly contradicted by context.

The term “unit” or “module”, as used herein, means, but is not limited to, a software or hardware component, such as a field programmable gate array (FPGA) or an application specific integrated circuit (ASIC), which performs certain tasks. A unit or module may be configured to reside in the addressable storage medium and configured to execute on one or more processors. Thus, a unit or module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units or modules may be combined into fewer components and units or modules or further separated into additional components and units or modules

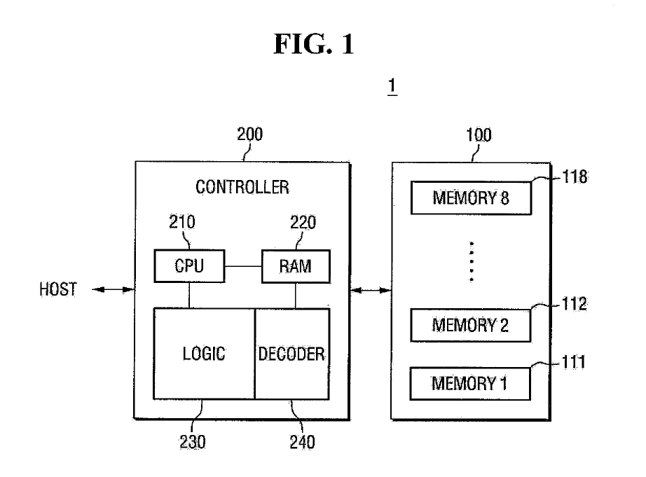

Hereinafter, a non-volatile memory device in accordance with an exemplary embodiment of the present inventive concept will be described with reference to FIGS. 1 to 4.

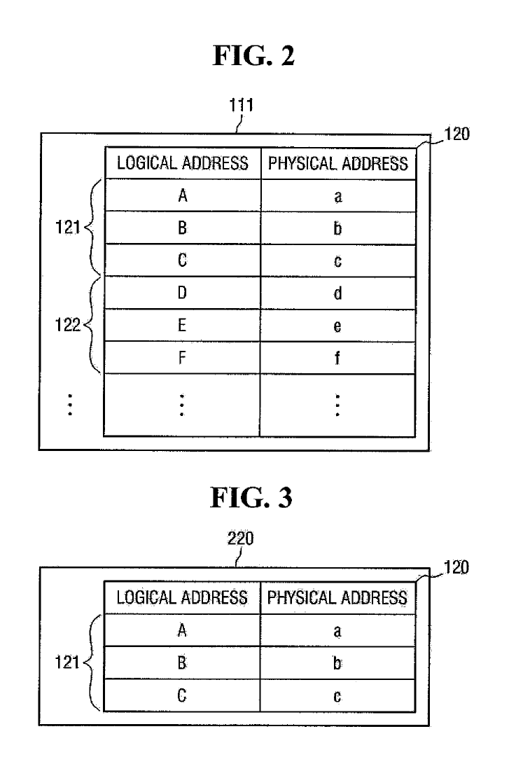

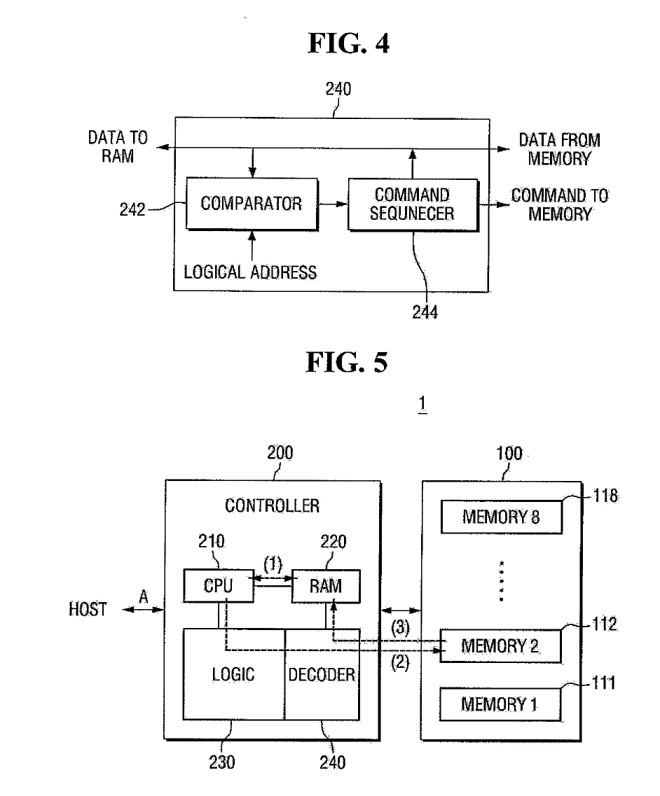

FIG. 1 is a block diagram showing a non-volatile memory device in accordance with an exemplary embodiment of the present inventive concept. FIG. 2 is a diagram for explaining a first memory unit shown in FIG. 1. FIG. 3 is a diagram for explaining a second storage unit shown in FIG. 1. FIG. 4 is a detailed block diagram of a decoder shown in FIG. 1 according to an exemplary embodiment of the present inventive concept.

Referring to FIG. 1, a non-volatile memory device 1 includes a first storage unit 100 and a controller 200.

The first storage unit 100 may include a plurality of memory units 111 to 118. In an exemplary embodiment of the present inventive concept, each of the memory units 111 to 118 may be a non-volatile memory chip. Each of the memory units 111 to 118 may be, e.g., a flash memory chip. While FIG. 1 illustrates eight memory units, the inventive concept is not limited thereto as there may be a lesser or greater number of memory units.

A case where the first storage unit 100 of this embodiment is configured with flash memory chips will be described below as an example, but the present inventive concept is not limited thereto. In at least one embodiment of the present inventive concept, the first storage unit 100 is configured with, e.g., variable resistance memory chips. The variable resistance memory means a memory which stores data using a phenomenon in which the resistance of a material varies according to an applied signal. Examples of the variable resistance memory include a magnetic RAM (MRAM) in which the variable resistance is implemented by using a magnetic change in a tunneling magneto-resistive (TMR) film, a phase change memory (PCM or PRAM) in which the variable resistance is implemented by using a phase change phenomenon of chalcogenide alloys, and a resistive RAM (PRAM) in which the variable resistance is implemented by using a resistance change in a resistance change film. The flash memory can be replaced with the variable resistance memory if necessary.

Further, a case where the first storage unit 100 of this embodiment is configured with, e.g., eight flash memory chips will be described below as an example, but the present inventive concept is not limited thereto. If necessary, the number of the flash memory chips included in the first storage unit 100 may be modified in various ways. For example, there may be less than eight flash memory chips or more than eight flash memory chips.

One of the memory units 111 to 118 constituting the first storage unit 100 may store mapping information between logical addresses used by a host and physical addresses used by the first storage unit 100. The following description will be made assuming that the mapping information is stored in the first memory unit 111 among the memory units 111 to 118 constituting the first storage unit 100, but the location of the memory unit in which the mapping information is stored may be changed if necessary. For example, the mapping information may be located in another one of the memory units.

Referring to FIG. 2, the first memory unit 111 may include mapping information 120 containing a plurality of physical addresses corresponding to a plurality of logical addresses. Here, physical addresses “a to f” may refer to addresses of the memory units 112 to 118, but not addresses of the first memory unit 111. For example, if the physical address ‘d’ is an address of the second memory unit 112, in the case where the host requests data corresponding to the logical address ‘D’ from the controller 200, in response thereto, the controller 200 may return data stored at the physical address ‘d’ of the second memory unit 112.

In an exemplary embodiment of the present inventive concept, the mapping information 120 stored in the first memory unit 111 is stored in and divided among a plurality of blocks 121, 122 . . . as illustrated in FIG. 2. Then, in the case where the controller 200 requests the mapping information 120 from the first memory unit 111, any one block containing the logical address provided from the host may be provided to the controller 200.

Referring again to FIG. 1, the controller 200 may be connected to the host and the first storage unit 100 as illustrated (e.g., via a physical or wireless connection). In response to the request from the host, the controller 200 may be configured to access the first storage unit 100. For example, the controller 200 may be configured to control read, write, erase and background operations of the first storage unit 100.

The controller 200 may be configured to provide an interface between the first storage unit 100 and the host. Further, the controller 200 may be configured to drive firmware for controlling the first storage unit 100.

The controller 200 may include a central processing unit (CPU) 210, a second storage unit 220, a logic circuit 230, a host interface (not shown), and a memory interface (not shown).

The central processing unit 210 may be controlled by, e.g., software, and may control overall operations of the controller 200.

The second storage unit 220 may be used as at least one of an operating memory of the central processing unit 210, a cache memory between the first storage unit 100 and the host, and a buffer memory between the first storage unit 100 and the host. In this embodiment, the second storage unit 220 may be a memory of a type different from that of the first storage unit 100. For example, when the first storage unit 100 is a flash memory, the second storage unit 220 may be a random access memory (RAM).

In an exemplary embodiment of the present inventive concept, the storage capacity of the second storage unit 220 may be smaller than the storage capacity of the first storage unit 100. Accordingly, the mapping information 120 between the physical addresses and the logical addresses stored in the second storage unit 220 may be a portion of the mapping information stored in the first memory unit 111. Referring to FIG. 3, the mapping information 120 stored in the second storage unit 220 may be any one (e.g., block 121) among the blocks 121, 122 . . . stored in the first memory unit 111.

The host interface (not shown) may include a protocol for performing data exchange between the host and the controller 200. The controller 200 may be configured to communicate with an external device (host) through at least one of various interface protocols, e.g., a universal serial bus (USB) protocol, multimedia card (MMC) protocol, peripheral component interconnection (PCI) protocol, PCI-express (PCI-E) protocol, advanced technology attachment (ATA) protocol, serial-ATA protocol, parallel-ATA protocol, small computer small interface (SCSI) protocol, enhanced small disk interface (ESDI) protocol, and integrated drive electronics (IDE) protocol.

The memory interface (not shown) may interface with the first storage unit 100. For example, the memory interface (not shown) may include a NAND interface or NOR interface.

The logic circuit 230 may apply various commands to the first storage unit 100 under control of the central processing unit 210. Also, in response thereto, if data is provided from the first storage unit 100, the logic circuit 230 may serve as a data path to provide the data to the second storage unit 220. The logic circuit 230 may be implemented by a combination of various logic elements (e.g., OR, NOR, AND, NAND, inverter gates, etc.) or a field-programmable gate array.

In this embodiment, the logic circuit 230 may include a decoder 240. The decoder 240 in accordance with an exemplary embodiment of the present inventive concept may be implemented by a combination of various logic elements as described above. In the case where the decoder 240 is implemented by a combination of various logic elements and a read command is applied to the first storage unit 100 through the control of hardware, the operating speed can be improved as compared to a case where a read command is applied to the first storage unit 100 through the control of software.

Hereinafter, a detailed configuration of the decoder 240 in accordance with an exemplary embodiment of the present inventive concept will be described in more detail with reference to FIG. 4.

Referring to FIG. 4, the decoder 240 may include a comparator 242 and a command sequencer 244.

The decoder 240 may serve to sequentially compare the logical address provided from the host with addresses of the mapping information provided to the second storage unit 220 from the first storage unit 100, and locate the physical address corresponding to the logical address provided from the host.

When the comparator 242 locates the physical address corresponding to the logical address provided from the host, the command sequencer 244 may apply a read command for reading data stored at the located physical address to the first storage unit 100. The comparator 242 may apply the read command immediately upon the comparator locating the physical address. A detailed operation of the decoder 240 and the command sequencer 244 will be described later.

Referring again to FIG. 1, the non-volatile memory device 1 may be configured to additionally include an error correction block (not shown). The error correction block may be configured to detect and correct an error of data read from the first storage unit 100 using an error correction code (ECC). For example, the error correction block (not shown) may be provided as a component of the controller 200, or may be provided as a component of the first storage unit 100.

Hereinafter, the operation of the non-volatile memory device 1 in accordance with an exemplary embodiment of the present inventive concept will be described with reference to FIGS. 5 to 8.

FIG. 5 is a diagram for explaining a read operation of the non-volatile memory device in accordance with an exemplary embodiment of the present inventive concept.

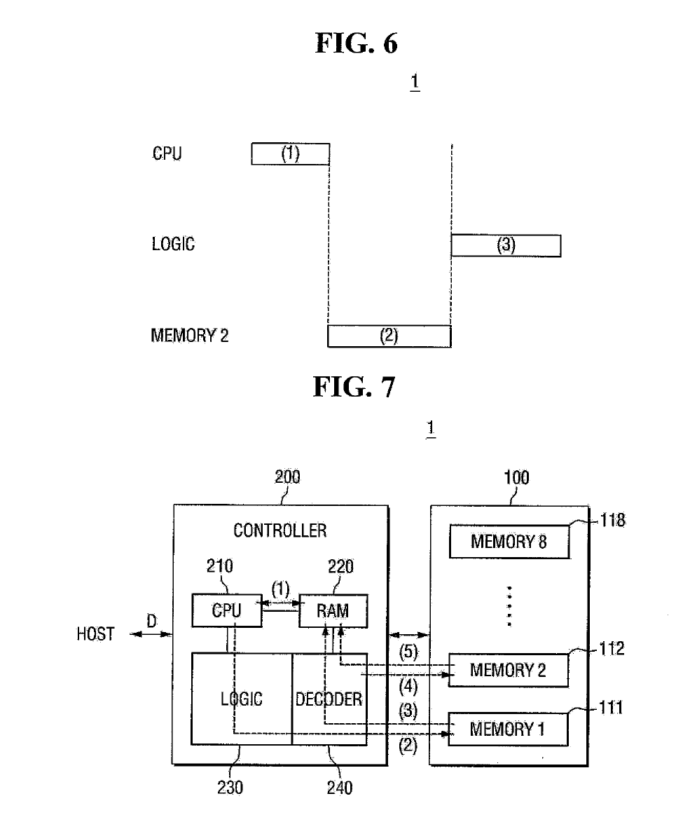

FIG. 6 is a diagram showing exemplary operation timings of the components shown in FIG. 5. FIG. 7 is a diagram for explaining a read operation of the non-volatile memory device in accordance with an exemplary embodiment of the present inventive concept.

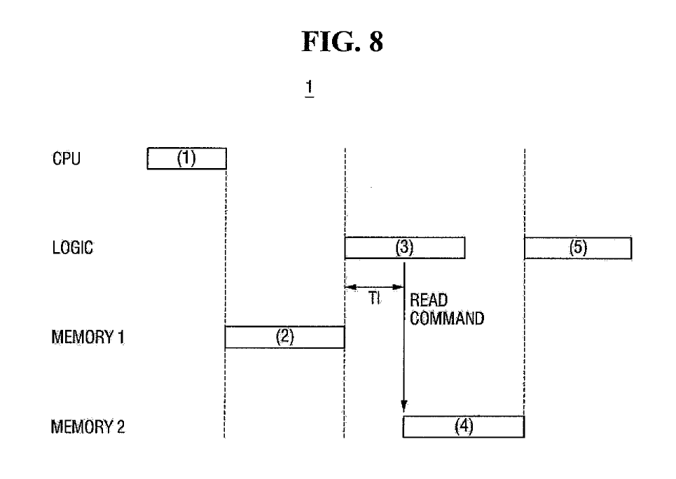

FIG. 8 is a diagram showing exemplary operation timings of the components shown in FIG. 7.

The read operation of the non-volatile memory device 1 will be described below assuming that, as described above, the mapping information 120 between the logical addresses and the physical addresses shown in FIG. 2 is stored in the first memory unit 111, and one block 121 of the mapping information 120 is stored in the second storage unit 220 as shown in FIG. 3. However, such is assumed for the convenience of description as the inventive concept is not limited thereto. For example, the mapping information 120 could be located in a different memory unit.

Referring to FIGS. 5 and 6, if a read command for reading data corresponding to the logical address ‘A’ from the host is applied, the central processing unit 210 checks whether the physical address ‘a’ corresponding to the logical address ‘A’ is stored in the second storage unit 220 (time period (1)). In this embodiment, since the mapping information on the physical address ‘a’ corresponding to the logical address ‘A’ exists in the second storage unit 220 as shown in FIG. 3, in this case, the second storage unit 220 returns the physical address ‘a’ to the central processing unit 210.

If the physical address ‘a’ is returned from the second storage unit 220, the central processing unit 210 applies a read command for reading data corresponding to the physical address ‘a’ to the first storage unit 100 through the logic circuit 230. In this case, if the data corresponding to the physical address ‘a’ is stored in the second memory unit 112, the read command is applied to the second memory unit 112 of the first storage unit 100 as illustrated.

If the read command for reading data corresponding to the physical address ‘a’ is applied, the second memory unit 112 reads the data corresponding to the physical address ‘a’ from a storage area (e.g., memory cell array) included therein, and loads the data into a page buffer (not shown) or the like (time period (2)).

If the data corresponding to the physical address ‘a’ is loaded into the page buffer (not shown) of the second memory unit 112, the logic circuit 230 receives the data and transmits the data to the second storage unit 220 (time period (3)). Then, the central processing unit 210 returns the data corresponding to the logical address ‘A’ stored in the second storage unit 220 to the host.

As described above, if the mapping information on the physical address corresponding to the logical address requested by the host exists in the second storage unit 220, the controller 200 does not need to further request additional mapping information from the first storage unit 100 in a data read process. However, when the storage capacity of the second storage unit 220 is smaller than the storage capacity of the first storage unit 100, the second storage unit 220 cannot store all of the mapping information 120 as shown in FIG. 2, and stores only a portion of the mapping information 120 (e.g., any one block among a plurality of blocks). Accordingly, if the mapping information on the physical address corresponding to the logical address requested by the host does not exist in the second storage unit 220, it is required to request additional mapping information stored in the first storage unit 100. Hereinafter, an operation in this case will be described with reference to FIGS. 7 and 8.

Referring to FIGS. 7 and 8, if a read command for reading data corresponding to the logical address ‘D’ from the host is applied, the central processing unit 210 checks whether the physical address ‘d’ corresponding to the logical address ‘D’ is stored in the second storage unit 220 (time period (1)). In this embodiment, since the mapping information on the physical address corresponding to the logical address ‘D’ does not exist in the second storage unit 220 as shown in FIG. 3, the second storage unit 220 cannot return the physical address ‘d’ to the central processing unit 210.

Since the physical address has not been returned from the second storage unit 220, the central processing unit 210 applies a read command for locating the physical address corresponding to the logical address ‘D’ to the first storage unit 100 through the logic circuit 230. In this case, if the mapping information between the logical addresses and the physical addresses is stored in the first memory unit 111, the read command is applied to the first memory unit 111.

The first memory unit 111, to which the read command has been applied, reads the mapping information 120 (see FIG. 2) stored therein, and loads it into a page buffer (not shown) or the like (time period (2)). In this case, since the storage capacity of the second storage unit 220 is relatively smaller than that of the first memory unit 111, the first memory unit 111 may load only a block (e.g., block 122 of FIG. 2) including the physical address ‘d’ corresponding to the logical address ‘D’ in the page buffer (not shown) rather than load all of the mapping information 120 (see FIG. 2) stored therein in the page buffer (not shown).

If the block (e.g., block 122 of FIG. 2) including the physical address ‘d’ corresponding to the logical address ‘D’ is loaded in the page buffer (not shown) of the first memory unit 111, the logic circuit 230 receives it and transmits it to the second storage unit 220 (time period (3)). While the block (e.g., block 122 of FIG. 2) including the physical address ‘d’ corresponding to the logical address ‘D’ is provided to the second storage unit 220, the decoder 240 included in the logic circuit 230 according to this embodiment sequentially retrieves the addresses of the provided block (e.g., block 122 of FIG. 2) and, when the physical address ‘d’ corresponding to the logical address ‘D’ is provided, applies a read command for reading data corresponding to the physical address to the first storage unit 100. The read command may be applied immediately upon the providing of the physical address ‘d’. If the data corresponding to the physical address ‘d’ is stored in the second memory unit 112, the decoder 240 sequentially retrieves addresses of the provided block (e.g., block 122 of FIG. 2) and, when the physical address ‘d’ corresponding to the logical address ‘D’ is located, applies a read command for reading data corresponding to the physical address ‘d’ to the second memory unit 112. The read command may be applied immediately upon the locating of the physical address ‘d’. This operation of the decoder 240 will be described below in more detail with reference to FIG. 4.

While a portion (e.g., block 122 of FIG. 2) of the blocks of the mapping information is provided to the second storage unit 220 from the page buffer (not shown) of the first memory unit 111, the comparator 242 sequentially retrieves addresses of the provided block to locate the physical address ‘d’ corresponding to the logical address ‘D’ provided from the host. Then, when the comparator 242 locates the physical address ‘d’ corresponding to the logical address D provided from the host, the command sequencer 244 applies a read command for reading data corresponding to the located physical address ‘d’ to the second memory unit 112. The read command may be applied immediately upon the comparator 242 locating the physical address ‘d’.

If the read command for reading data corresponding to the physical address ‘d’ is applied from the decoder 240, the second memory unit 112 reads the data corresponding to the physical address from the storage area (e.g., memory cell array) included therein, and loads the data into the page buffer (not shown) or the like (time period (4)). That is, in this embodiment the operation (time period (3)) in which a portion (e.g., block 122 of FIG. 2) of the blocks of the mapping information is provided from the page buffer (not shown) of the first memory unit 111 to the second storage unit 220 through the logic circuit 230 and the decoder 240, and the operation (time period (4)) in which the second memory unit 112 reads the data corresponding to the physical address ‘d’ from the storage area included therein and loads the data in the page buffer (not shown) or the like are performed to overlap each other as shown in FIG. 8. In the non-volatile memory device 1 in accordance with an exemplary embodiment of the present inventive concept, by performing the operation of time period (3) and the operation of time period (4) to overlap each other, it is possible to reduce the amount of a read time required for reading the stored data.

In this embodiment, a first time period T1 from a time point (e.g., start point of time period (3)) when a portion (e.g., block 122 of FIG. 2) of the blocks of the mapping information is provided from the page buffer (not shown) of the first memory unit 111 to the second storage unit 220 through the logic circuit 230 and the decoder 240 to a time point (e.g., start point of time period (4)) when the decoder 240 applies the read command for reading data corresponding to the physical address ‘d’ to the second memory unit 112 is not fixed to a constant period. This is because the first time period T1 may vary according to the value of the logical address provided from the host, and may also vary according to how the configuration of the mapping information 120 stored in the first memory unit 111 is changed.

As one example, if the logical address provided from the host is the logical address ‘F’ instead of the logical address ‘D’ described above, the first time period T1 may be longer than that shown in FIG. 8. This is because the time required for the comparator 242 to locate the physical address ‘D’ corresponding to the logical address ‘F’ may be longer than the time required to locate the physical address ‘d’ corresponding to the logical address ‘D’ if the physical address ‘f’ corresponding to the logical address ‘F’ is provided to the decoder 240 later than the physical address ‘d’ corresponding to the logical address ‘D’. That is, in this embodiment, the first time period T1 is not fixed to a constant period.

Then, if the data corresponding to the physical address ‘d’ is loaded into the page buffer (not shown) of the second memory unit 112, the logic circuit 230 receives the data and transmits the data to the second storage unit 220 (time period (5)). Then, the central processing unit 210 returns the data corresponding to the logical address ‘D’ stored in the second storage unit 220 to the host.

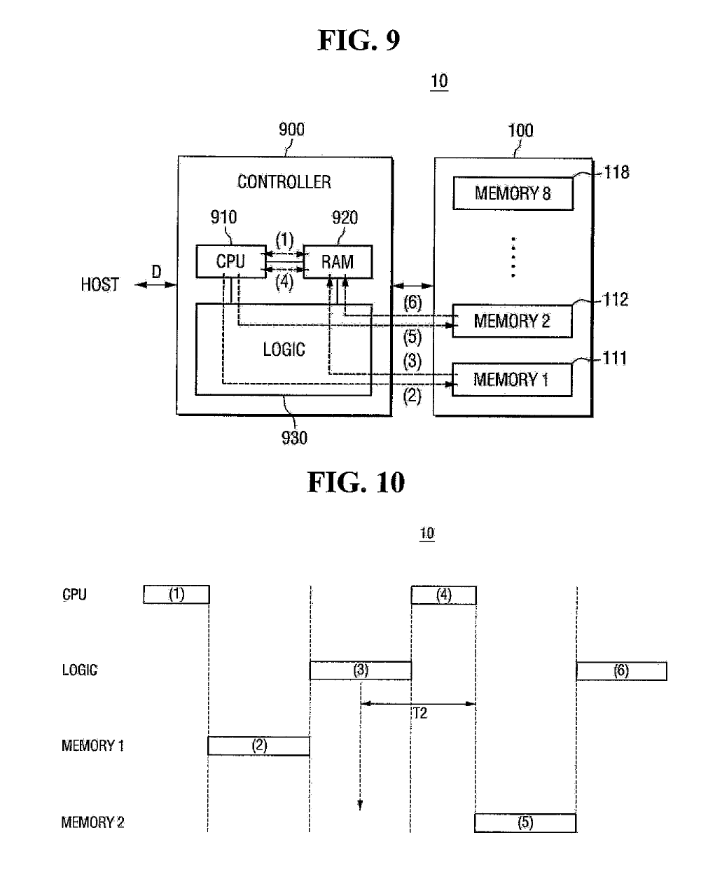

Hereinafter, a more detailed description will be given of how to reduce the read time required for reading the stored data in the non-volatile memory device in accordance with an exemplary embodiment of the present inventive concept with reference to FIGS. 9 and 10.

FIGS. 9 and 10 are diagrams for explaining the effect of the non-volatile memory device in accordance with an exemplary embodiment of the present inventive concept. FIG. 9 is an exemplary diagram of a non-volatile memory device having a configuration different from the configuration of the non-volatile memory device described with respect to FIGS. 1-8. FIG. 10 is a diagram showing exemplary operation timings of the components shown in FIG. 9.

An effect of the non-volatile memory device 1 in accordance with an exemplary embodiment of the present inventive concept will be explained below, assuming that a read command for reading data corresponding to the logical address ‘D’ from the host is also applied to a non-volatile memory device 10 shown in FIG. 9, and a read operation thereof will be explained.

Referring to FIGS. 9 and 10, if a read command for reading data corresponding to the logical address ‘D’ from the host is applied, a central processing unit 910 checks whether the physical address ‘d’ corresponding to the logical address D is stored in a second storage unit 920 (time period (1)). In this embodiment, since the mapping information on the physical address ‘d’ corresponding to the logical address ‘D’ does not exist in the second storage unit 920, the second storage unit 920 cannot return the physical address ‘d’ to the central processing unit 910.

Since the physical address ‘d’ has not been returned from the second storage unit 920, the central processing unit 910 applies a read command for locating the physical address ‘d’ corresponding to the logical address ‘D’ to the first memory unit 111 through a logic circuit 930.

The first memory unit 111, to which the read command has been applied, reads a portion (e.g., block 122 of FIG. 2) of the blocks of the mapping information the mapping information 120 (see FIG. 2) is stored therein, and loads it into the page buffer (not shown) or the like (time period (2)).

If the block (e.g., block 122 of FIG. 2) including the physical address ‘d’ corresponding to the logical address ‘D’ is loaded into the page buffer (not shown) of the first memory unit 111, the logic circuit 930 receives it and transmits it to the second storage unit 920 (time period (3)).

Once again, the central processing unit 910 checks whether the physical address ‘d’ corresponding to the logical address ‘D’ is stored in the second storage unit 920 (time period (4)). At this time, since the mapping information on the physical address ‘d’ corresponding to the logical address ‘D’ exists in the second storage unit 920, the second storage unit 920 returns the physical address ‘d’ to the central processing unit 910 (time period (4)).

If the physical address ‘d’ is returned from the second storage unit 920, the central processing unit 910 applies a read command for reading data corresponding to the physical address to the second memory unit 112 through the logic circuit 930. Then, if the read command for reading data corresponding to the physical address ‘d’ is applied, the second memory unit 112 reads the data corresponding to the physical address ‘d’ from a storage area (e.g., memory cell array) included therein, and loads the data into the page buffer (not shown) or the like (time period (5)).

If the data corresponding to the physical address ‘d’ is loaded into the page buffer (not shown) of the second memory unit 112, the logic circuit 930 receives the data and transmits the data to the second storage unit 920 (time period (6)). Then, the central processing unit 910 returns the data corresponding to the logical address ‘D’ stored in the second storage unit 920 to the host.

As described above, it can be seen that in the non-volatile memory device 10 having a configuration different from that of the non-volatile memory device 1 in accordance with an exemplary embodiment of the present inventive concept, it takes a second time T2 longer than the non-volatile memory device 1 in accordance with an exemplary embodiment of the present inventive concept to read the data corresponding to the logical address ‘D’ (see total time of FIG. 8 and total time of FIG. 10 for comparison).

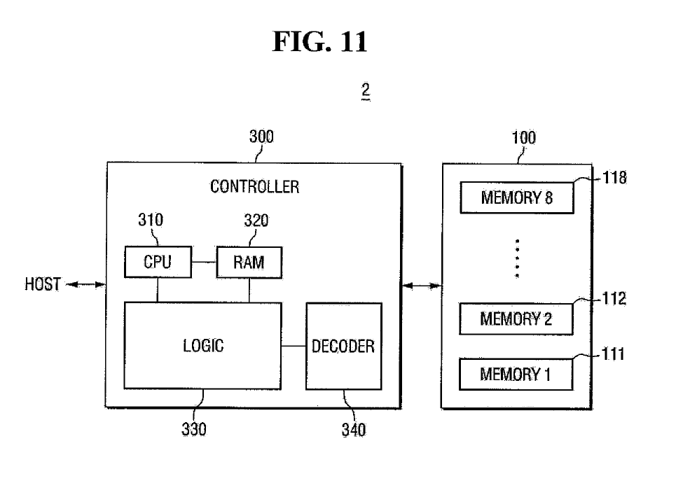

Hereinafter, a non-volatile memory device in accordance with an exemplary embodiment of the present inventive concept will be described with reference to FIG. 11.

FIG. 11 is a block diagram showing a non-volatile memory device in accordance with an exemplary embodiment of the present inventive concept.

Referring to FIG. 1I, a non-volatile memory device 2 includes the first storage unit 100 and a controller 300.

The first storage unit 100 may include a plurality of memory units 111 to 118, and each of the memory units 111 to 118 may be configured as, e.g., a flash memory chip.

The controller 300 may be connected to the host and the first storage unit 100 (e.g., via a physical or a wireless connection). In response to a request from the host, the controller 300 may be configured to access the first storage unit 100. For example, the controller 300 may be configured to control read, write, erase and background operations of the first storage unit 100.

The controller 300 may include a central processing unit (CPU) 310, a second storage unit 320, a logic circuit 330, a host interface (not shown), and a memory interface (not shown).

The central processing unit 310 may be controlled by, e.g., software, and may control overall operations of the controller 300. The second storage unit 320 may be used as at least one of an operating memory of the central processing unit 310, a cache memory between the first storage unit 100 and the host, and a buffer memory between the first storage unit 100 and the host. In this embodiment, the second storage unit 320 may be a random access memory (RAM).

The host interface (not shown) may include a protocol for performing data exchange between the host and the controller 300. The memory interface (not shown) may include, e.g., a NAND interface or NOR interface to interface with the first storage unit 100.

The logic circuit 330 may apply various commands to the first storage unit 100 under control of the central processing unit 310. Also, in response thereto, if data is provided from the first storage unit 100, the logic circuit 330 may serve as a data path to provide the data to the second storage unit 320. The logic circuit 330 may be implemented by a combination of various logic elements.

In this embodiment, a decoder 340 may be disposed separately from the logic circuit 330 as illustrated. The decoder 340 disposed separately from the logic circuit 330 may be implemented by a combination of various logic elements in the same way as the logic circuit 330, or may be implemented by separate software or the like. That is, in this embodiment, the implementation type and method of the decoder 340 are not limited particularly.

The operation of the non-volatile memory device 2 may be similar to the operation of the non-volatile memory device 1 in accordance with the above-described exemplary embodiment of the present inventive concept. Accordingly, it may be possible to reduce the read time required for reading data stored in the first storage unit 100.

According to an exemplary embodiment of the present inventive concept, a non-volatile memory device includes a controller comprising an internal memory storing only a first part of mapping information and a memory storage unit distinct from the controller, and storing the entire mapping information. The controller is configured to refer first to its internal memory to find a physical address that corresponds to a received logical address, and next refers to the memory storage unit to perform the find if the physical address is not found within the internal memory. The controller may reference its internal memory and the memory storage unit in response to a read command received from a host external to the memory device. The internal memory (e.g., 220, 920, etc.) may have a smaller capacity than the memory storage unit (e.g., 100). However, the inventive concept is not limited thereto. For example, the internal memory could have a similar or a larger capacity than the memory storage unit. The remaining portion of the internal memory not used to store the first part of the mapping information could be used to store other data (e.g., a boot code, an operating system, data corresponding to a physical address in mapping information, etc.).

In an exemplary embodiment of the inventive concept, if the controller (e.g., 200, 900, etc.) finds the physical address within the memory storage unit, the controller overwrites the first part of the internal memory with a second part of the entire mapping information in the memory storage unit that includes the physical address. If the internal memory has capacity larger than the first part, the remaining part of the internal memory is left alone and not overwritten. The second part may have a same size as the first part. If the second part is smaller than the first part, only a part of the first part is overwritten. The second part may include a logical address that maps to the physical address, and may additionally include several other logical addresses that map to other physical addresses. In an exemplary embodiment, the controller performs the overwriting during a first part of a period of time, and a reading of data from the memory storage unit corresponding to the physical address during a second part of the period of time, where the first and second parts overlap with one another (e.g., see time periods (3) and (4) in FIG. 8). The controller may include a first logic circuit (e.g., 230) to perform the overwriting and a second other logic circuit (e.g., decoder 240) to perform the reading. The controller may include a CPU (e.g., 210, 910) that is sent the read data and which forwards the data to the host.

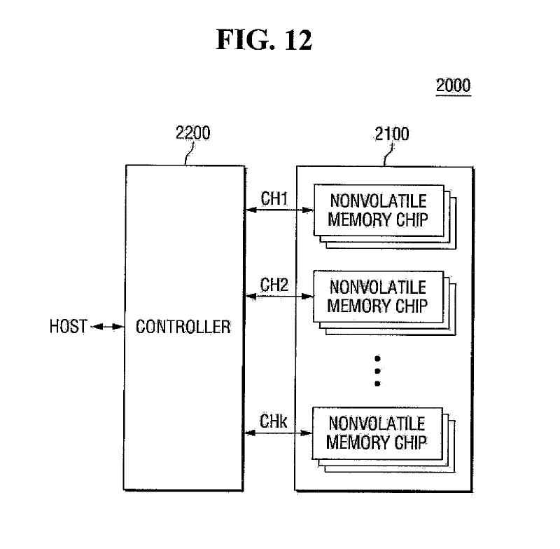

Next, an application example of the non-volatile memory device in accordance with an exemplary embodiment of the present inventive concept will be described with reference to FIG. 12.

FIG. 12 is a block diagram showing an application example of the non-volatile memory device in accordance with an exemplary embodiment of the present inventive concept.

Referring to FIG. 12, the non-volatile memory device in accordance with the embodiment of the present inventive concept may be applied to a memory system 2000 as shown in FIG. 12.

The memory system 2000 may include a plurality of memory chips 2100 and a controller 2200. The plurality of memory chips 2100 may be classified into a plurality of groups as illustrated. Each group of the memory chips 2100 may be configured to perform communication with the controller 2200 via one common channel. For example, the memory chips 2100 may perform communication with the controller 2200 via first to k-th channels CHI to CHk as illustrated.

The controller 2200 and the memory chips 2100 may be integrated into a single semiconductor device. For example, the controller 2200 and the memory chips 2100 may be integrated into a single semiconductor device to form a memory card. Examples of the memory card include a PC card (PCMCIA, personal computer memory card international association), a compact flash card (CF), a smart media card (SM, SMC), a memory stick, a multimedia card (MMC, RS-MMC, MMCmicro), an SD card (SD, miniSD, microSD, SDHC), and a universal flash storage (UFS). However, the present inventive concept is not limited to any particular memory card type.

The controller 2200 and the memory chips 2100 may be integrated into one semiconductor device to form a semiconductor drive (e.g., a solid sate drive (SSD)). The semiconductor drive includes a storage device configured to store data in a semiconductor memory. In a case where the memory system 2000 is used as the semiconductor drive, the operating speed of the host connected to the memory system 2000 may be improved.

Further, the controller 2200 and the memory chips 2100 may be mounted as various types of packages. For example, the controller 2200 and the memory chips 2100 may be mounted as a package such as package on package (PoP), ball grid arrays (BGAs), chip scale packages (CSPs), plastic leaded chip carrier (PLCC), plastic dual in line package (PDIP), die in waffle pack, die in wafer form, chip on board (COB), ceramic dual in line package (CERDIP), plastic metric quad flat pack (MQFP), thin quad flat pack (TQFP), small outline (SOIC), shrink small outline package (SSOP), thin small outline (TSOP), thin quad flat pack (TQFP), system in package (SIP), multi chip package (MCP), wafer-level fabricated package (WFP), and wafer-level processed stack package (WSP).

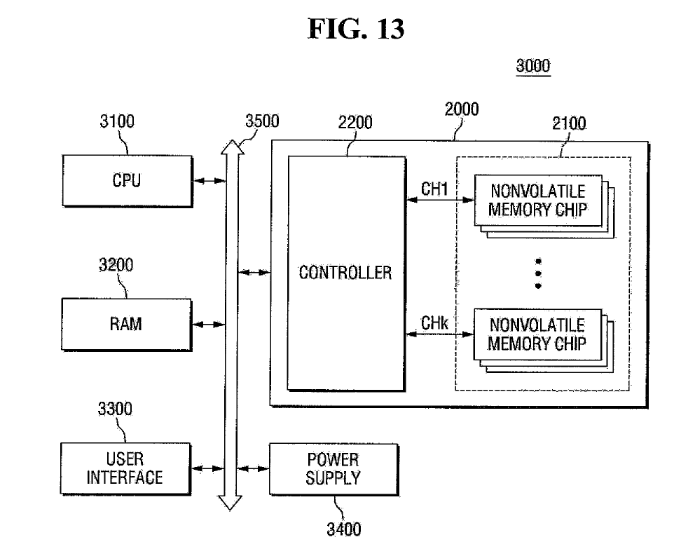

Next, a computing system including the non-volatile memory device in accordance with an exemplary embodiment of the present inventive concept will be described with reference to FIG. 13.

FIG. 13 is a block diagram showing a computing system including the non-volatile memory device in accordance with an exemplary embodiment of the present inventive concept.

Referring to FIG. 13, a computing system 3000 includes a central processing unit 3100, a random access memory (RAM) 3200, a user interface 3300, a power supply 3400, and the memory system 2000.

The memory system 2000 may be electrically connected to the central processing unit 3100, the RAM 3200, the user interface 3300 and the power supply 3400 via a system bus 3500. The data provided through the user interface 3300 or processed by the central processing unit 3100 may be stored in the memory system 2000.

FIG. 13 illustrates a case where the memory chips 2100 are connected to the system bus 3500 through the controller 2200. However, the memory chips 2100 may be configured to be directly connected to the system bus 3500 differently from the illustrated case.

The computing system 3000 may be provided as one of various components of an electronic device such as a computer, a ultra mobile personal computer (UMPC), a workstation, a net-book, a personal digital assistance (PDA), a portable computer (PC), a web tablet, a wireless phone, a mobile phone, a smart phone, an e-book, a portable multimedia player (PMP), a portable game console, a navigation device, a black box, a digital camera, a digital multimedia broadcasting (DMB) player, a digital audio recorder, a digital audio player, a digital picture recorder, a digital picture player, a digital video recorder, a digital video player, a device for transmitting and receiving information in a wireless environment, one of various electronic devices constituting a home network, one of various electronic devices constituting a computer network, one of various electronic devices constituting a telematics network, a radio frequency identification (RFID) device, and one of various components constituting a computing system, but the present invention is not limited thereto.

Although the present inventive concept has been described in connection with exemplary embodiments thereof, those skilled in the art will appreciate that various modifications can be made to these embodiments without substantially departing from the principles of the present inventive concept.

What is claimed is:

1. A non-volatile memory device comprising:
a first storage unit which stores mapping information between a plurality of first addresses and a plurality of second addresses, and data;
a second storage unit having a storage capacity smaller than that of the first storage unit; and
a decoder which receives a first read address that is one of the plurality of first addresses, and while the mapping information is provided from the first storage unit to the second storage unit to locate a second read address that is one of the plurality of second addresses and corresponds to the first read address, applies a read command for reading data corresponding to the second read address to the first storage unit.

2. The non-volatile memory device of claim 1, wherein the first addresses comprise logical addresses used by a host, and
the second addresses comprise physical addresses used by the first storage unit.

3. The non-volatile memory device of claim 1, wherein the first storage unit comprises a first memory unit and a second memory unit which are separated from each other,
the mapping information is stored in the first memory unit,
the data is stored in the second memory unit, and
while the mapping information is provided from the first memory unit to the second storage unit, the decoder applies a read command for reading data corresponding to the second read address to the second memory unit.

4. The non-volatile memory device of claim 3, wherein the first and second memory units comprise flash memories, and
the second storage unit comprises a random access memory (RAM).

5. The non-volatile memory device of claim 1, further comprising a controller which controls an operation of the first storage unit,
wherein the second storage unit and the decoder are disposed in the controller.

6. The non-volatile memory device of claim 5, wherein the controller comprises a central processing unit and a logic circuit to control the operation of the first storage unit, and
the decoder is disposed in the logic circuit.

7. The non-volatile memory device of claim 5, wherein the controller comprises a central processing unit and a logic circuit to control the operation of the first storage unit, and
the decoder is disposed separately from the logic circuit.

8. The non-volatile memory device of claim 1, wherein the decoder comprises:
a comparator which sequentially compares the received first read address with the mapping information provided from the first storage unit to locate the second read address; and
a command sequencer which applies the read command to the first storage unit when the comparator locates the second read address.

9. The non-volatile memory device of claim 1, wherein the mapping information is dispersedly stored among a plurality of blocks, and
the mapping information provided from the first storage unit to the second storage unit is one of the plurality of blocks.

10. A non-volatile memory device comprising:
a first storage unit which stores ‘n’ physical addresses corresponding to ‘n’ logical addresses, wherein ‘n’ is a natural number;
a second storage unit which stores data; and
a controller which in response to a first read command applied to read data corresponding to a first logical address, while ‘m’ physical addresses including a first physical address corresponding to the first logical address among the ‘n’ physical addresses stored in the first storage unit are provided from the first storage unit, applies a second read command for reading data corresponding to the first physical address to the second storage unit, wherein ‘m’ is a natural number less than or equal to ‘n’.

11. The non-volatile memory device of claim 10, wherein the first storage unit and the second storage unit are memory chips of the same type.

12. The non-volatile memory device of claim 11, wherein the controller comprises:
a third storage unit which stores the ‘m’ physical addresses provided from the first storage unit in response to the first read command; and
a decoder which applies the second read command to the second storage unit while the ‘m’ physical addresses are provided from the first storage unit to the third storage unit.

13. The non-volatile memory device of claim 12, wherein the third storage unit has a storage capacity smaller than that of the first storage unit or the second storage unit.

14. The non-volatile memory device of claim 13, wherein the first and second memory units comprise flash memories, and
the second storage unit comprises a random access memory (RAM).

15. The non-volatile memory device of claim 12, wherein the decoder comprises:
a comparator which locates the first physical address corresponding to the first logical address among the ‘m’ physical addresses sequentially provided from the first storage unit; and
a command sequencer which applies the second read command to the second storage unit when the comparator locates the first physical address.

16. A non-volatile memory device comprising:
a controller comprising an internal memory storing only a first part of mapping information; and
a memory storage unit distinct from the controller, and storing the entire mapping information,
wherein the controller is configured to refer first to its internal memory to find a physical address that corresponds to a received logical address, and next refers to the memory storage unit to perform the find if the physical address is not found within the internal memory,
wherein if the controller finds the physical address within the memory storage unit, the controller overwrites the first part with a second part of the entire mapping information that includes the physical address,
wherein the controller performs the overwriting during a first part of a period of time, and a reading of data from the memory storage unit corresponding to the physical address during a second part of the period of time, wherein the first and second parts overlap with one another.

17. The non-volatile memory device of claim 16 further comprises:
a first logic circuit to perform the overwriting; and
a second logic circuit to perform the reading, wherein the first and second logic circuits are distinct from one another.

18. The non-volatile memory device of claim 16, wherein the second part includes at least one other physical address that is mapped to another logical address.
